(19) United States
(12) Patent Application Publication
(10) Pub. No.: US 2011/0256389 A1
(43) Pub. Date: Oct. 20, 2011

(54) Compressor Anti-Corrosion Protection Coating

(75) Inventor: Karl J. Dendis, Interlaken, NY (US)

(73) Assignee: CARRIER CORPORATION, Farmington, CT (US)

(21) Appl. No.: 12/809,317

(22) PCT Filed: Dec. 18, 2007
(86) PCT No.: PCT/US07/25928

§ 371 Date: Jul. 7, 2011

(51) Int. Cl. B32B 15/08; B05D 3/02; B05D 1/36; B32B 5/00; B05D 1/08

(52) U.S. Cl. 428/337; 428/457; 428/422.8; 427/407.1; 427/454; 427/385.5; 428/425.5

(57) ABSTRACT

A corrosion and abrasion resistant multilayer coating protects a compressor operating in a marine environment. The coating includes a thermal sprayed cermet layer and an organic based sealant layer.

### BACKGROUND

The present invention relates generally to compressors. In particular the invention relates to an abrasion resistant corrosion protection coating.

Corrosion protection of compressors in marine environments is a serious and critical issue. Compressors are typically manufactured from plain carbon steels or cast iron and are highly susceptible to rust and other forms of corrosion products, particularly in the salt laden air of a marine environment. Corrosion degrades the structural integrity of compressor components, and failure of those containing high pressure fluids can lead to personal bodily harm as well as costly damages and repair.

Prior art coatings for compressors for corrosion protection in marine environments include painting, electrostatic powder coating or flame or electric arc sprayed metallic coatings. Surface preparation for painting includes washing followed by a basecoat application followed by a topcoat application. Surface preparation for electrostatic powder coating includes shot blast, wash, phosphatize, E-coat, and cure. A major drawback with painted and powder coated surfaces is that the coatings are weak and prone to penetration by any sharp object. Even a pinhole will initiate corrosion that can lead to eventual penetration and component failure. Paint containing metallic fillers is also used for corrosion protection. A common filler is zinc because zinc is sacrificial to iron and steel in a galvanic sense and will corrode before any iron or steel in the vicinity of a corroding area is attacked.

Flame or electric arc sprayed metallic coatings offer significant advantages over painted coatings. Aluminum is the preferred coating since it is sacrificial to iron and steel in a galvanic sense and will corrode before any iron or steel in the vicinity of a corroding area is attacked. In this process aluminum is flame sprayed on the surface to a thickness of up to 0.015 inches followed by an organic seal coat. Surface preparation includes optional chemical cleaning followed by grit blasting. The roughened grit blasted surface aids in mechanical adhesion of the aluminum coating. Providing the aluminum coating is thick enough, the surface is protected from impact and scratching because the aluminum will deform and remain on the surface. Flame and electric arc sprayed aluminum coatings are usually given an organic seal coat because the coatings typically contain porosity.

Elevated temperatures are a problem in compressors. Certain components (e.g. compressor heads and discharge shells) operate at temperatures in excess of 300° F. The organic coatings need to withstand these temperatures.

Although flame and arc sprayed aluminum coatings offer corrosion protection to cast iron and steel compressor components in marine environments, the coatings can be penetrated by impact or abrasion if the force is sufficient.

### SUMMARY

Exemplary embodiments of the invention include a compressor with a protective coating and a method of protecting the compressor shell from a corrosive marine environment. The protective coating includes a cermet layer on the outside surface of the compressor and an organic based sealant layer on the cermet layer. In the method, a cermet layer is applied to the outside surface of the compressor and an organic based sealant layer is applied on the cermet layer.

### BRIEF DESCRIPTION OF THE DRAWINGS

FIG. 1 is a schematic of a compressor body showing a thermal spray nozzle applying a cermet coating.

FIG. 2 is a schematic cross-section of a multilayer corrosion protection coating.

### DETAILED DESCRIPTION

If a metal coating is anodic to iron or steel in the electrochemical series, in a corrosive environment, that metal will corrode first before the base metal. In other words, the coating is sacrificial to the base metal. Aluminum and zinc are two examples of sacrificial coatings to iron and steel. Prior art examples of sacrificial coatings are paint containing zinc and flame sprayed aluminum. If portions of the coatings are removed by impact or abrasion with sharp objects, the protection is lost and the base metal will corrode in those regions. The abrasion resistance of prior art corrosion protection coatings on compressors in marine environments would benefit from increased abrasion resistance. Certain compressor components may reach operating temperatures that affect polymer coatings. A corrosion resistant coating for compressors with improved abrasion resistance and elevated temperature stability forms the basis of this invention.

A cermet is a composite material made up of ceramic particles in a metallic matrix. The ceramic imparts abrasion resistance to the structure, and the metal contributes ductility. The abrasion resistance and elevated temperature impact strength of cermets are typically superior to those of metal itself. Cermet coatings can be applied by thermal spraying using ceramic and metal powders as a feed stock. Flame spraying, electric arc spraying and plasma spraying can be used to apply cermet coatings. A sprayed cermet coating for use as a corrosion protection coating for compressors in marine environments is preferably an aluminum/aluminum oxide cermet preferably deposited by plasma spraying. The aluminum matrix provides sacrificial corrosion protection as well as impact resistance, and the aluminum oxide provides abrasion resistance and elevated temperature strength. Other metal/ceramic combinations also can be used. Examples include, but are not limited to, combinations of aluminum oxide, zirconium oxide or aluminum silicate combined with aluminum and/or zinc.

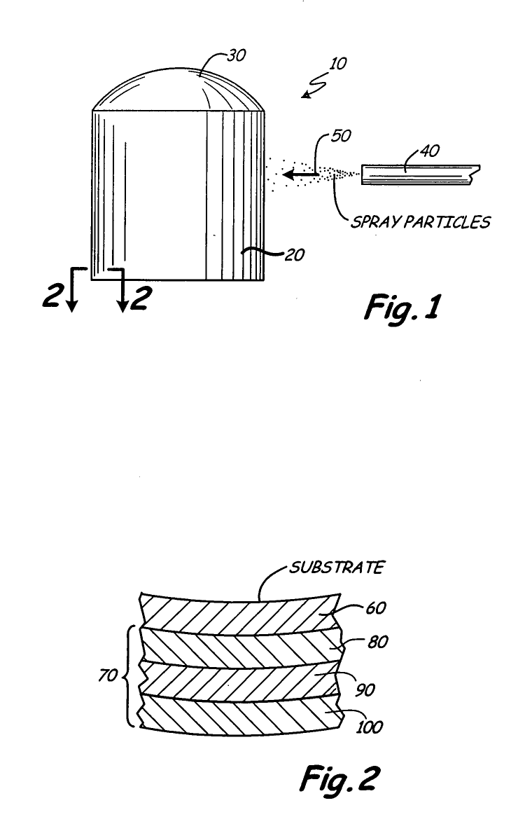

FIG. 1 shows a schematic of a compressor shell 10 and a thermal spray nozzle 40. Compressor shell 10 includes cylindrical body 20 and domed top 30. Other shapes for shell 10 including rectangular shapes, pipe fittings, electronic housings, etc. can be included but are not shown in the figure. Thermal spray nozzle 40 is shown directing thermal spray powder 50 at compressor shell 10 in a coating application process. The coating is a multilayer coating.

FIG. 2 is a schematic of cross-section 2-2 of multilayer corrosion protection coating 70 on compressor shell body 60. Corrosion protection coating 70 includes first layer 80, second layer 90, and third layer 100. First layer 80 is a plasma sprayed metal/ceramic cermet. The thickness of cermet layer 80 is from about 0.005 inches to about 0.020 inches; preferably the layer is about 0.015 inches thick. Preferably, cermet layer 80 is an aluminum/aluminum oxide cermet.

Cermet layer 80 is covered with sealant layer 90. Sealant layer 90 can be an organic based protective layer containing a solvent and other inorganic materials applied by spraying or brushing, or it can be an organic based powder layer applied by electrostatic spraying. Preferably sealant layer 90 is an electrostatic thermosetting polyester powder layer. Thermosetting polyester powders include, but are not limited to, triglycidyl isocyanurate (TGIC), hydroxyl-alkylamide, digyclidal epoxy and methylated TGIC. Specifically, triglycidyl isocyanurate (TGIC) polyester powder coating is preferred.

Optional topcoat layer 100 can be included for added protection and/or for cosmetic appearance. Topcoat layer 100 can be a polyurethane polymer, urethane base acrylic, epoxy polymide or other polymeric coatings. Topcoat layer 100 is applied by spraying, brushing or powder coating.

Before compressor shell 10 is coated, it needs to be thoroughly cleaned and degreased. Aqueous alkaline industrial cleaning solutions can be used. If the compressor components are cast iron, additional surface preparation may be necessary to remove any graphite on the surface that will inhibit adhesion of the coating. A number of companies offer cleaning techniques to remove graphite from the surface of cast iron. For example, the Kolene electrolytic salt process is known in the industry.

In order to remove additional surface contamination and expose fresh steel or iron, the compressor shell may be treated by abrasive grit blasting. Grit blasting also serves to mechanically anchor the cermet coating to the substrate. The grit blasting should satisfy the surface finish requirements of SSPC SP 5 or NACE1 “white metal”. The preferred grit media is aluminum oxide with a mesh size of about 16-30. Improved adhesion of the cermet results when the substrate has an irregular surface texture formed by angular shaped grit particles. The resulting surface finish of the substrate after blasting is preferred to have an anchor tooth pattern with a surface profile of about 0.0015 to about 0.0025 inch measured by ASTM D 4417 method A, B or C. It is preferred that 100% of the surfaces to be metalized are cleaned prior to deposition of a cermet coating. Regions of the compressor shell 10 that are not blasted should be masked.

Examples of such components are electrical connections, a sight glass or internal coupling threads.

In order to avoid the formation of flash rust or other forms of surface contamination that would otherwise inhibit adhesion of the cermet, compressor shell 10 should be free of moisture. Spraying can take place at room temperature, but local heating of the area to be sprayed is beneficial. As an alternative, compressor shell 10 may be placed in an oven at 250° F. to eliminate any surface moisture prior to plasma spraying. In any case, the air temperature shall be about 5° F. minimum above the dew point. Plasma spraying should take place within four hours after drying to obtain maximum coating adhesion. The surface quality of the ferrous substrate is preferably SSPC SP 5 “white metal” before spraying. The most preferred composition of the cermet feed stock is pure aluminum (99.9% minimum purity) powder and pure aluminum oxide powder. The composition of the cermet coating is aluminum about 35 to about 85 volume percent and aluminum oxide about 15 to about 65 volume percent. Specifically, about 75 volume percent aluminum and about 25 volume percent aluminum oxide is preferred. The coating thickness of the cermet is about 0.005 inches to about 0.025 inches and specifically about 0.015 inches is preferred.

The cermet coating can be powder flame sprayed, wire flame sprayed, electric arc wire sprayed, or plasma arc sprayed with plasma arc spraying being a preferred technique. Plasma arc spraying uses a thermal-plasma and is a versatile thermospraying process. The thermal-plasma, a dense highly ionized gas, has a sufficiently high enthalpy density to melt and deposit powders, virtually any metal alloy, or ceramic. DC (direct current) thermal-plasma spraying can spray powders at high velocities producing high coating density potentially approaching theoretical density. Plasma spraying results in fine, essentially equiaxed grains. The plasma flame is maintained by a steady continuous arc discharge of flowing inert gas (generally argon) plus a small percentage of enthalpy enhancing diatomic gas such as hydrogen. Feed stock powder (with particle sizes of about 0.0005 to about 0.003 inches in diameter) is carried by inert gas into the emerging plasma flame. The particles melt in transit without vaporizing excessively, are accelerated and impinge on the substrate where they flatten and solidify at cooling rates similar to those achieved in rapid solidification processes. The kinetic energy of the droplets cause deformation and flattening of the cermet particles as they hit the compressor body forming a uniform layer of aluminum/aluminum oxide cermet on the steel or iron surfaces. Because of the nature of this deposition process, a small amount of porosity may form between the particles of aluminum and aluminum oxide. Interconnected porosity that connects the substrate with the outlying atmosphere is not acceptable. The cermet coating preferably should be sufficiently thick to prevent interconnected porosity.

To further guarantee against porosity, a sealant coat is applied. A preferred coating for the plasma sprayed aluminum/aluminum oxide cermet is triglycidyl isocyanurate (TGIC) polyester powder coating. The coating is applied as an electrostatic powder spray and is cured from about 25 minutes at about 305° F. plus or minus 5° F. metal temperature to about 15 minutes at about 345° F. plus or minus 5° F. The preferred curing time is about 20 minutes at about 325° F. metal temperature. The sealant coat thickness should be between about 0.005 inches to about 0.025 inches. A thickness of about 0.015 inches is preferred. The US Navy uses this coating for shipboard components as per MIL Spec. MIL-PRF-24712.

Top coats such as polyurethane polymer, urethane base acrylic and epoxy polyamide can be applied to the polymer coating on the cermet for added protection and cosmetic appearance. The top coat can contain coloring agents as preferred. The top coat should be thin, for example about 0.003 to about 0.007 inches.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A compressor having a protective coating on an outside surface of the compressor, the protective coating comprising:
a cermet layer on the outside surface of the compressor; and
an organic based sealant layer on the cermet layer.

2. The compressor of claim 1, wherein the cermet layer is a plasma sprayed layer.

3. The compressor of claim 1, wherein the cermet layer comprises aluminum and aluminum oxide.

4. The compressor of claim 3, wherein the cermet layer comprises about 35 to about 85 volume percent aluminum, and about 15 to about 65 volume percent aluminum oxide.

5. The compressor of claim 1, wherein the cermet layer has a thickness of between about 0.005 to about 0.025 inches.

6. The compressor of claim 1, wherein the cermet layer has a thickness of about 0.015 inches.

7. The compressor of claim 1, wherein the organic based sealant layer comprises a triglycidyl isocyanurate polyester powder coating.

8. The compressor of claim 7, wherein the triglycidyl isocyanurate polyester powder coating has a thickness between about 0.005 to about 0.025 inches.

9. The compressor of claim 7, wherein the triglycidyl isocyanurate polyester powder coating has a curing temperature of about 305° F. plus or minus 10° F. to about 345° F. plus or minus 10° F.

10. The compressor of claim 1 and further comprising:
an organic based topcoat on the organic based surface layer.

11. The compressor of claim 10, wherein the organic base topcoat is a polyurethane polymer, urethane based acrylic or an epoxy polyimide.

12. A method of protecting a compressor shell from a corrosive marine environment, the method comprising:
applying a cermet layer on the outside surface of the compressor; and
applying an organic based sealant layer on the cermet layer.

13. The method of claim 12, wherein applying the cermet layer is by plasma spraying.

14. The method of claim 13, wherein the cermet layer is a powder plasma sprayed layer.

15. The method of claim 12, wherein the cermet layer comprises aluminum and aluminum oxide.

16. The method of claim 15, wherein the cermet layer comprises about 35 to about 85 volume percent aluminum, and about 15 to about 65 volume percent aluminum oxide.

17. The method of claim 12, wherein the cermet layer has a thickness of between about 0.005 to about 0.020 inches.

18. The method of claim 12, wherein the organic based sealant layer comprises triglycidyl isocyanurate polyester powder coating.

19. The method of claim 18 and further comprising:
curing the triglycidyl isocyanurate polyester powder coating for about 5 minutes to about 20 minutes at about 305° F. plus or minus 10° F. to about 345° F. plus or minus 10° F.

20. The method of claim 12 and further comprising:
applying an organic based topcoat on the organic based sealant layer.
